(19) United States
(12) Patent Application Publication
(10) Pub. No.: US 2026/0193065 A1
(43) Pub. Date: Jul. 9, 2026

(54) CABLE MANAGEMENT APPARATUS AND SYSTEM

(71) Applicant: IPALCO B.V., Rotterdam (NL)

(72) Inventor: Matthew AMY, Pittsboro, NC (US)

(73) Assignee: IPALCO B.V., Rotterdam (NL)

(21) Appl. No.: 19/012,428

(22) Filed: Jan. 7, 2025

(51) Int. Cl. B66C 23/64; B63B 27/00; B63B 27/10; B66C 13/22; B66C 23/18

(52) U.S. Cl. CPC B66C 23/64; B63B 27/10; B63B 27/29; B66C 13/22; B66C 23/18; B66C 2700/08

(57) ABSTRACT

A cable management apparatus for storing, dispensing and retracting an electrical cable. A housing encloses the electrical cable, the housing having a dispense opening defining a front end from which the electrical cable is dispensed and a rear end opposite the front end. A cable dispensing unit is disposed proximal to the dispense opening, the cable dispensing unit being configured to dispense the electrical cable from the dispense opening in a first operation mode. A movable biasing unit to receive a portion of the electrical cable and to apply a biasing force on the portion of the electrical cable towards the rear end such that the electrical cable is tensioned between the cable dispensing unit and the movable biasing unit, the movable biasing unit being configured to move along at least a portion of a length of the housing to cooperatively dispense the electrical cable with the cable dispensing unit.

### FIELD OF THE INVENTION

The present technology relates generally to a cable management apparatus in a cable management system for power transmission.

### BACKGROUND

The present disclosure relates to a cable management apparatus and system for facilitating shore (and other fixed points) power connections and subsequent power transmission between a local electric grid connection and marine vessels. Typically, the cables concerned are flexible cabling assemblies for low voltages e.g. 380 V, 400 V, 440 V, 690 V up to about 1000 kV AC or 1500 V DC, as well as high voltages e.g. 6.6 kV, 11 kV, 15 kV and occasionally higher e.g. 24 kV, each may include e.g. a continuous length of cable, an integrated connector for coupling with a corresponding input port on a marine vessel, and various cable-related equipment.

The present technology is particularly relevant to implementation partially within or around hazard zones, as classified by relevant industry and engineering standards bodies, for example requirements as defined, recommended, and informed by e.g. the IEEE/IEC 80005 and the Oil Companies International Marine Forum (OCIMF). An example may be shore power connections with liquid bulk vessels such as, but not limited to, chemical and crude oil tankers.

When such liquid bulk vessels are docked, gas vapours may be readily present within and around the operation area of a liquid bulk terminal since chemicals, crude oil, etc. is being actively transferred from a vessel to shore or from shore and the vessel. Under such circumstances, any spark caused by a cable management system within a designated hazard zone has the potential of causing an explosion that could harm personnel, destroy cargo, operational equipment and vessels within the explosion zone, and causing significant damages to the environment.

It is therefore desirable to provide an improved cable management device and system for supplying electricity that is capable of safely and effectively dispensing and retracting an electrical cable.

### SUMMARY

An aspect of the present technology provides a cable management apparatus for storing, dispensing and retracting an electrical cable, comprising: a housing to enclose the electrical cable, the housing having a dispense opening defining a front end from which the electrical cable is dispensed and a rear end opposite the front end; a cable dispensing unit disposed proximal to the dispense opening, the cable dispensing unit being configured to dispense the electrical cable from the dispense opening in a first operation mode; and a movable biasing unit disposed within the housing to receive a portion of the electrical cable and to apply a biasing force on the portion of the electrical cable towards the rear end such that the electrical cable is tensioned between the cable dispensing unit and the movable biasing unit, the movable biasing unit being configured to move along at least a portion of a length of the housing to cooperatively dispense the electrical cable with the cable dispensing unit.

According to examples of the present technology, in addition to a cable dispensing unit, the cable management apparatus further comprises a movable biasing unit that cooperates with the cable dispensing unit to safely and effectively dispense the electrical cable. In particular, the movable biasing unit receives a part of the cable and applies a biasing force on the received part of the cable, which pulls that part of the cable towards the rear end of the housing. Thus, the movable biasing unit maintains tension on the cable between the cable dispensing unit and the movable biasing unit itself. This arrangement allows the electrical cable, which is typically bulky and heavy, to be stored vertically, horizontally and anywhere in between without excessive or uncontrolled slack and so without any part of the cable resting on top of another part of the cable. Being able to safely store the cable at any inclinations improves the reach of the overall arrangement, in that the cable management apparatus itself may be controlled to reach towards the target before dispensing the cable. More importantly, when the cable is being dispensed by the cable dispensing unit, tensioning the cable between the cable dispensing unit and the movable biasing unit allows the cable to be dispensed without the risk (or at least with a reduced risk) of a part of the cable being dragged over another part of the cable, which could result in damages to the cable and/or sparks due to friction.

The cable dispensing unit may be configured in the first operation mode to dispense the electrical cable by drawing a length of the electrical cable out of the dispense opening, and in a second operation mode to retract the electrical cable by drawing the length of electrical cable into the housing. In the first operation mode, the cable dispensing unit draws the electrical cable out of the dispense opening against the biasing force towards the rear end of the housing applied by the movable biasing unit, and causes the cable to be dispensed while under tension. In the second operation mode, the cable dispensing unit retracts the cable by operating in reverse and drawing the cable into the housing, aided by the biasing force towards the rear end of the housing applied by the movable biasing unit which maintains the tension.

The biasing force of the movable biasing unit may be generated in any suitable and desirable manners, including simple spring or hydraulic actuator arrangements. The movable biasing unit may comprise a drive unit configured to generate and control the biasing force towards the rear end of the housing. Using a drive unit allows the biasing force to be adjustable and controllable for cooperation with the cable dispensing unit.

When the cable dispensing unit is in the first operation mode, the drive unit may be configured to reduce the biasing force towards the rear end of the housing based on a dispense speed of the cable dispensing unit to allow the movable biasing unit to move towards the dispense opening, such that a predetermined tension in the electrical cable is maintained while the cable dispensing unit dispenses the electrical cable. By reducing the biasing force towards the rear end of the housing to allow movement of the movable biasing unit towards the dispense opening, more length of the cable is made available for dispensing. Since the drive unit controls the biasing force based on a dispense speed of the cable dispensing unit, such that the movement of the movable biasing unit forward is coordinated with the speed at which the cable dispensing unit dispenses the electrical cable, the drive unit effectively maintains the biasing force towards the rear end of the housing, and the desired tension in the electrical cable is maintained as the cable dispensing unit draws the cable towards the dispense opening.

The cable dispensing unit is configured in a second operation mode to retract the electrical cable by drawing the length of electrical cable into the housing, and the drive unit may be configured to increase the biasing force towards the rear end of the housing based on a retract speed of the cable dispensing unit when the cable dispensing unit is in a second operation mode, such that a predetermined tension in the electrical cable is maintained while the cable dispensing unit retracts the electrical cable. Increasing (or restoring) the biasing force towards the rear end of the housing when the cable dispensing unit is in the second operation (recovery) mode brings the cable towards the rear end of the housing, thus facilitating the retraction of the cable for storage.

The cable dispensing unit may be configured in a third operation (static) mode to be static, and the drive unit may be configured to maintain the biasing force towards the rear end of the housing so as to maintain a predetermined tension in the electrical cable for storage.

The movable biasing unit may be arranged to move along the length or part of the length of the housing in any suitable ways. The cable management apparatus may further comprise a rail disposed within the housing extending at least the portion of the length of the housing, wherein the drive unit is slidably coupled to the rail.

The movable biasing unit may be any suitable shapes and sizes as desired. The movable biasing unit may be configured and dimensioned to maintain a bending radius in the received portion of the electrical cable at or above a minimum bending radius. Thus, for example, the movable biasing unit may be a sheave with a curvature appropriate for meeting the minimum bending radius of the cable, and/or it may comprise one or more rollers and/or cable guides that together result in an appropriate curvature.

The cable management apparatus may be configured such that the cable dispensing unit and movable biasing unit together form a modular pair that can be straightforwardly scaled to accommodate more than one electrical cables within the same housing of the cable management apparatus. The cable management apparatus may comprise a plurality of cable dispensing units and a plurality of movable biasing units, wherein each pair of cable dispensing unit and movable biasing unit may be configured to cooperatively dispense and retract a corresponding electrical cable.

Another aspect of the present technology provides a cable management system for facilitating electrical power transmission to a marine vessel, comprising: a crane having a support base, the crane comprising a crane arm pivotally coupled to the support base, the crane arm extending from a proximal end near the support base to a distal end away from the support base, and a crane interface at the distal end of the crane arm; a cable management apparatus of any preceding claim pivotally coupled to the crane interface; and at least one electrical cable.

The cable management system may further comprise a monitoring system comprising at least one sensor, the at least one sensor may be configured to sense: a position of the crane, a position of the cable management apparatus, a mechanical force being exerted on the at least one electrical cable, a temperature of the at least one electrical cable, one or more obstructions near the crane, the cable management apparatus and/or the at least one electrical cable. The monitoring system comprising at least one sensor enables the cable management system to be, in a sense, self-aware, in that the cable management system is able to sense its surroundings during operation to allow for e.g. notifications and alarming, adjustments, starting and stopping, etc.

The monitoring system may further comprise a control module configured to: switch the cable dispensing unit to the ON state, switch the cable dispensing unit to an OFF state, set or adjust a speed or rate the cable dispensing unit dispenses the at least one electrical cable, set or adjust a speed or rate the movable biasing unit retracts the at least one electrical cable, set or adjust an elevation and/or rotation of the crane arm, set or adjust an elevation and/or rotation of the cable management apparatus, perform an emergency stop on a movement of the crane arm and/or the cable management apparatus, and/or generate a warning, based on sensor data output by the at least one sensor. In doing so, it is possible to operate the cable management system semi-autonomously or fully autonomously. In some situations, if the monitoring system detects an abnormality such as an unavoidable obstacle, excessive tension in the cable, excessive operating temperature, etc., generating a warning enables a human operator to independently verify and respond to the abnormality.

The at least one electrical cable may comprise a plurality of electrical cables, and the cable management apparatus may comprise a corresponding plurality of cable dispensing units and movable biasing unit pairs, wherein each cable dispensing unit and movable biasing unit pair may be configured to cooperatively dispense or retract a corresponding electrical cable of the plurality.

The electrical cable may be a medium to high voltage flexible cable.

The cable management system may be deployed in a non-hazardous area or partially in a hazard zone to facilitate electrical power transmission within the hazard zone, such as when the marine vessel is a liquid bulk vessel including a chemical tanker or a crude oil tanker.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

Examples will now be described, with reference to the accompanying drawings, in which:

FIG. 1 shows an exemplary cable management apparatus according to an examples;

FIG. 2 shows an exemplary cable management apparatus according to an example;

FIG. 3 shows an exemplary cable management system according to an example;

FIG. 4 shows an exemplary cable management system according to an example; and

FIG. 5 sows an exemplary cable management system according to an example.

### DETAILED DESCRIPTION

The present technology relates to power transmission from shore or other fixed points and provides a cable management apparatus for use in a cable management system for safely and efficiently dispensing and retracting bulky electrical cables. The present technology is particularly relevant to power transmission within or around hazard zones, such as around a loading or offloading liquid bulk vessel carrying hazardous liquid such as chemicals or crude oil. As fumes may be present around the operation area, any spark within or around the zone may cause a fire or explosion. It is therefore desirable to minimise the likelihood of generating excessive heat or creating a spark during power transmission.

The present technology therefore seeks to provide an improved cable management apparatus and system for power transmission from shore and other fixed points that is capable of safely and effectively dispensing and retracting an electrical cable. A cable management apparatus according to the examples comprises a movable biasing unit that cooperates with a cable dispensing unit to safely and effectively dispense an electrical cable. In particular, the movable biasing unit receives a part of the cable and applies a biasing force on the received part of the cable to pull the cable towards the rear end of the housing away from the dispense opening. The biasing force of the movable biasing unit maintains tension on the cable when the cable dispensing unit is engaged with the cable. This arrangement allows a typically bulky and heavy electrical cable to be stored vertically, horizontally and at any inclinations without slack to prevent any part of the cable resting on top of another part of the cable. The ability to safely store the cable at any inclinations improves the reach of the overall arrangement, in that the cable management apparatus storing the cable may be controlled to reach towards the target before dispensing the cable. More importantly for hazard zone deployment, tensioning the cable between the cable dispensing unit and the movable biasing unit when the cable is being dispensed reduces the risk of a part of the cable being dragged over another part of the cable, resulting in damages to the cable and/or sparks from friction.

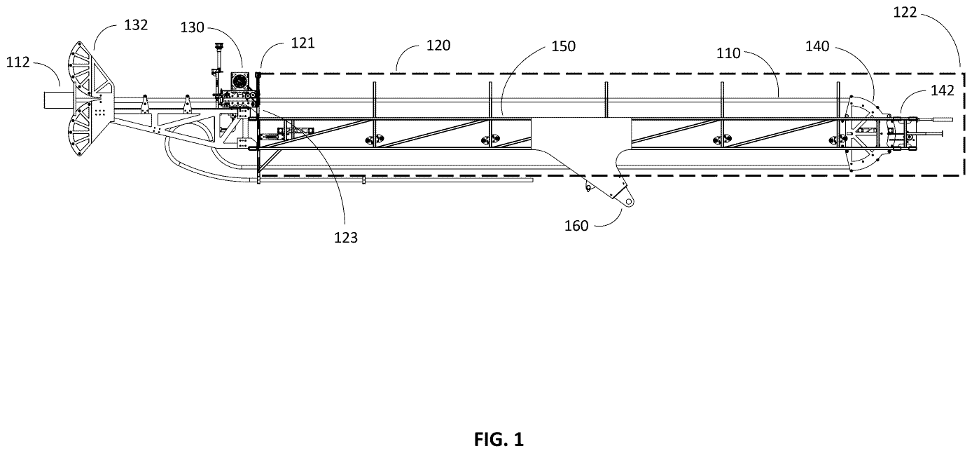

FIG. 1 shows an exemplary cable management apparatus 100 according to an example. The cable management apparatus 100 comprises a housing 120 for storing and protecting an electrical cable 110. The housing 120 has a dispense opening 123 at one end, which defines a front end 121 of the housing, and a rear end 122 opposite the front end 121. The cable management apparatus 100 comprises a cable dispensing unit 130, which is configured in a first operation (dispense) mode to draw the cable 110 out of the dispense opening 123 to dispense the cable 110, in a second operation (retract/recovery) mode to retract or recover the cable 110 back into the housing 120, and in a third operation (static) mode remain static while the cable 110 is in the housing 120 for storage. The cable 110 is provided with a connector 112 that is configured to couple to a corresponding port e.g. of a docked marine vessel to deliver electrical power. A cable guide 132 is provided to guide the cable 110 as it is dispensed and to receive the connector 112 when the cable 110 is retracted. In the present example, the cable guide 132 is configured with a rounded opening such that a minimum bend radius in the cable 110 is maintained as the cable 110 is in use.

The cable management apparatus 100 further comprises a movable biasing unit 140, which receives a portion of the cable 110 and applies a biasing force on that portion of the cable 110 towards the rear end 122 of the housing 120. In the present example, the movable biasing unit 140 is a sheave coupled to a drive unit 142 that drives the movable biasing unit 140 along a substantial length of the housing 120 on a rail 150. The sheave (and other cable guides if desired) further advantageously maintains a minimum bending radius of the cable throughout storage and operations. However, other implementations are possible so long as the movable biasing unit is capable of receiving a portion of the cable 110 and applying a biasing force on the cable 110 towards the rear end 122. For example, the movable biasing unit may be spring-loaded or coupled to a hydraulic actuator, etc. The present implementation based on a sheave 140 and drive unit 142 has an advantage that the biasing force is controllable and adjustable through the drive unit 142.

The biasing force applied to the cable 110 by the movable biasing unit 140 maintains a tension on the cable 110 against the cable dispensing unit 130 to reduce, or altogether eliminate, any excessive or uncontrolled slack in the cable 110. In particular, the movable biasing unit 140 is controlled in coordination with the cable dispensing unit 130, such that the biasing force applied to the cable 110 by the movable biasing unit 140 is adjusted or changed based on the speed (or rate) at which the cable dispensing unit 130 dispenses or retracts the cable 110 so as to maintain a desired tension in the cable 110 e.g. according to manufacturer specifications. In doing so, it is possible to arrange the cable 110 as a loop while maintaining a distance between the overlapping portion of the cable 110, as shown in FIG. 1, without any part of the cable 110 resting against another part, and when the cable 110 is being moved through the housing 120, i.e. when the cable is being dispensed or retracted, no part of the cable 110 is dragged over and rubbing against another part of the cable 110. Thus, the risk of undesirably compressing the cable 110 and the risk of generating excessive heat or causing sparks due to friction are minimised.

In operation, the movable biasing unit 140 cooperates with the cable dispensing unit 130 to dispense and retract the cable 110. More specifically, to dispense the cable 110, the cable dispensing unit 130 is switched to the first operation mode to begin drawing at least a portion of the cable 110 out of the dispense opening 123, and at the same time (or immediately before or subsequently), the drive unit 142 operates to reduce the biasing force towards the rear end 122, which allows the movable biasing unit 140 to move towards the dispense opening 123 to allow more of the length of the cable 110 to be available for dispensing. Moreover, the drive unit 142 adjust the biasing force of the movable biasing unit 140 based on the speed (or rate) at which the cable dispensing unit 130 dispenses the electrical cable 110, such that an effective biasing force towards the rear end 122 of the housing 120 is applied to maintain a desired tension in the cable 110. In doing so, a predetermined tension in the electrical cable 110 is maintained while the cable dispensing unit 130 dispenses the electrical cable 110. Then, to retract or recover the cable 110, the cable dispensing unit 130 is switched to the second operation mode to draw the cable 110 back into the housing 120, i.e. the cable dispensing unit 130 is operated in reverse, while at the same time (or immediately before or subsequently), the drive unit 142 is controlled to increase the biasing force applied to the cable 110 by the movable biasing unit 140. The adjustment of the biasing force of the movable biasing unit 140 is based on the speed (or rate) at which the cable dispensing unit 130 is drawing the cable 110. This causes the movable biasing unit 140 to return to the rear end 122 of the housing 120 while bringing a portion of the cable 110 with it, thus retracting the dispensed portion of the cable 110 back into the housing 120 while maintaining a desired tension along the cable 110.

Lastly, the cable management apparatus 100 is provided with an interface 160 for coupling with a corresponding interface e.g. on a structure.

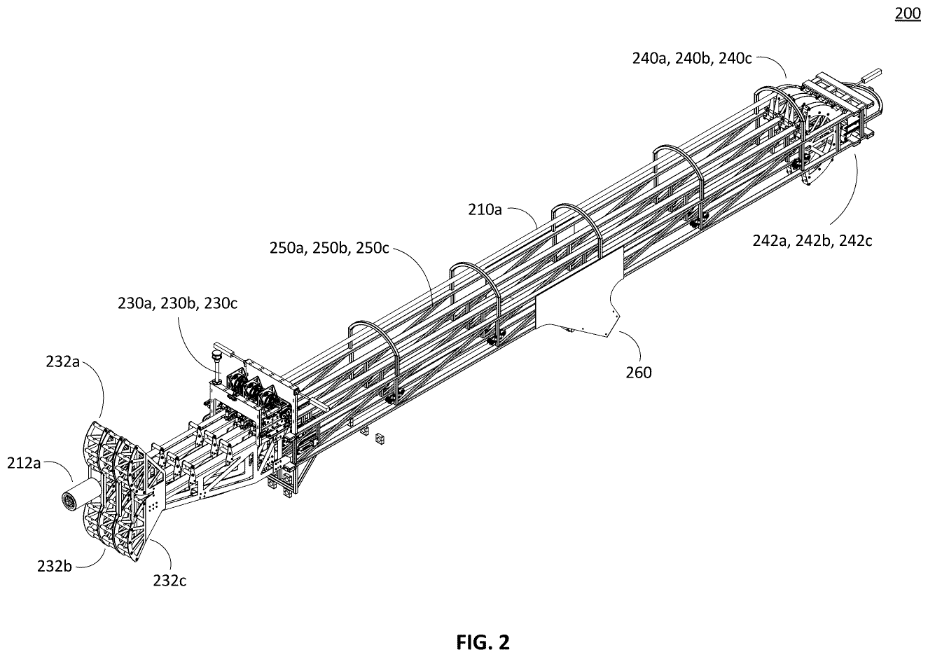

The cable management apparatus 100 may be implemented modularly, with each cable management module comprising at least a cable dispensing unit and movable biasing unit cooperating pair that cooperatively dispenses and retracts a corresponding electrical cable. A cable management apparatus may be provided with multiple modules for dispensing (and retracting) multiple cables enclosed within the same housing. An example is shown in FIG. 2, which shows an exemplary cable management apparatus 200 according to an example.

The cable management apparatus 200 differs from the cable management apparatus 100 of FIG. 1 in that three cable management modules are provided. In particular, the cable management apparatus 200 comprises cable dispensing units 230a, 230b, 230c provided with guards 232a, 232b, 232c, and movable biasing units 240a, 240b, 240c driven by respective drive units 242a, 242b, 242c along rails 250a, 250b, 250c. The cable management apparatus 200 is provided with an interface 260 for coupling with a corresponding interface of a structure.

In the present example, only one electrical cable 210a is shown for simplicity; however, it is to be understood that each module may be provided with its own cable. The operation of each module is substantially the same as the cable management apparatus 100 and will not be repeated.

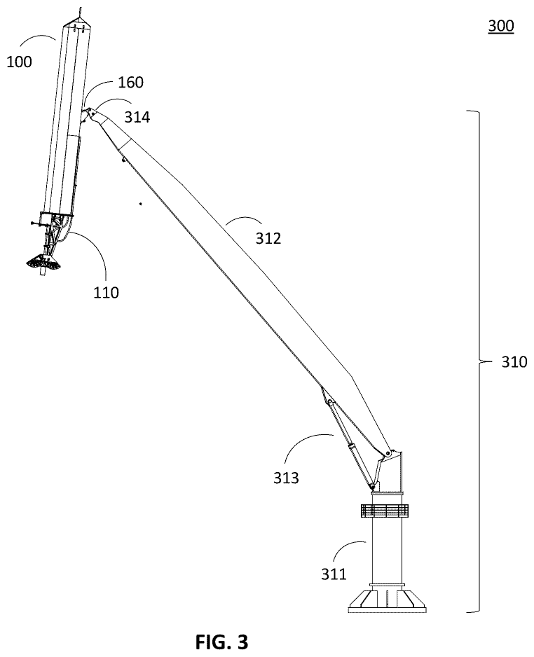

The cable management apparatus 100, the cable management apparatus 200, or other cable management apparatuses with any number of modules may be used in a cable management system for power transmission. FIG. 3 shows an exemplary cable management system 300 according to an example.

The cable management system 300 comprises a crane 310 and a cable management apparatus such as the cable management apparatus 100 coupled to the crane 310. The crane 310 comprises a support base 311 that is fixed to the ground through suitable means. The crane 310 may comprise a rotation (slewing) system in the support base 311 to enable the slewing/rotation movement of the cable management system 300 that allows full or partial rotation around its axis. Slewing/rotation may be performed by one or more hydraulic motors driving the rotation system, and slew/rotation speed and position may be controlled by a proportional directional control valve. The crane 310 further comprises a crane arm 312 pivotally coupled to the base 311 that can be raised and lowered by an actuator 313. Proximity to the support base 311 defines a proximal end of the crane arm 312 with the opposite end of the crane arm 312 defines a distal end. At the distal end of the crane arm 312 is a crane interface 314 configured to couple with the interface 160 of the cable management apparatus 100 to secure the cable management apparatus 100 to the crane 310.

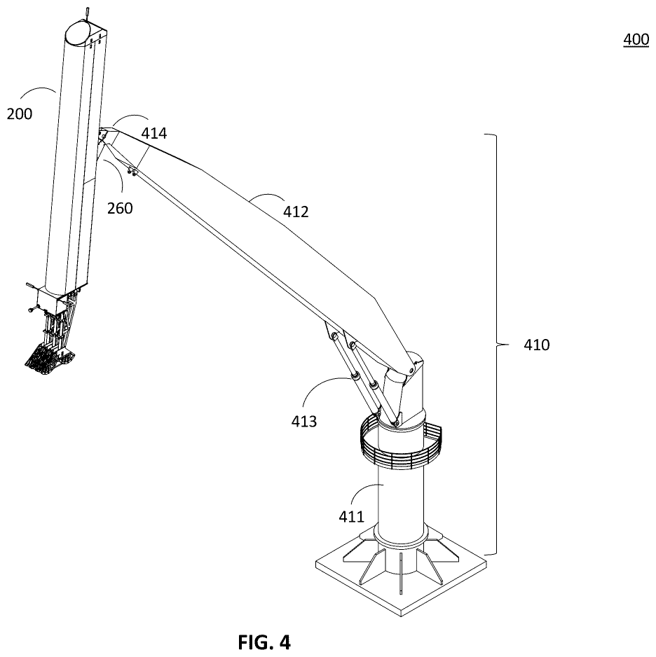

FIG. 4 shows another exemplary cable management system 400. The cable management system 400 comprises a crane 410 having a rotatable support base 411 and a crane arm 412, controlled by actuators 413. A crane interface 414 is provided at the distal end of the crane arm 412. The cable management system 400 differs from the cable management system 300 in that the cable management system 400 comprises the cable management apparatus 200 with multiple cable management modules for dispensing (and retracting) multiple electrical cables. The cable management apparatus 200 is coupled to the crane 410 through the coupling of the interface 260 with the crane interface 414.

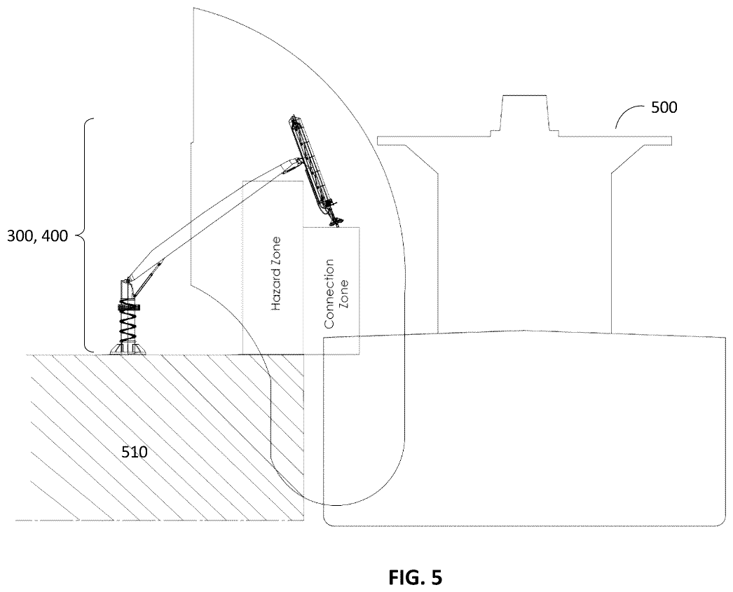

In operation, as illustrated in FIG. 5, a cable management system such as the cable management system 300 or 400 is installed at shore 510, e.g. just outside of or partially within a hazard zone. The support base of the crane is controlled to rotate to a position to enable the crane arm to reach towards the connection zone, e.g. of a docked marine vessel 500, where a connection port is located. The actuator of the crane arm is then controlled to lower the crane arm to position the cable management apparatus closer to the vessel 500. The crane interface can then be controlled to move the cable management apparatus to a suitable orientation (e.g. more horizontal) as necessary to approach the vessel 500, at which point the cable can be dispensed out of the cable management apparatus as described above to reach the connection port. During operation, if the position of the vessel 500, and therefore the connection port, changes, for example changes in height due to tidal variations, the cable management apparatus may adjust the length of the cable, and/or the crane may adjust the inclination of the crane arm and/or the orientation of the cable management apparatus, as necessary.

The cable management system 300 and/or 400 may be provided with a monitoring system that comprises one or more sensors communicating with a control module. The use of such a monitoring system enables the cable management system to sense its surroundings during operation e.g. to allow for adjustments, which provides the cable management system with the capability of “self-awareness” to a certain extent. For example, various proximity sensors, temperature sensors, tension sensors, etc. may be provided to the monitoring system, to sense e.g. the position of the crane, the position of the cable management apparatus, the mechanical force (e.g. tension, compression) being exerted on an electrical cable, the temperature of the electrical cable, any obstructions near the crane, the cable management apparatus or the electrical cable, etc.

Using sensor data received from the sensors, the control module of the monitoring system can determine the cable management system is operating as expected. If the control module determines that the cable management system is not operating as expected, for example if the operating temperature exceeds a maximum temperature, if obstructions are detected, or if excessive mechanical force is detected at the cable, etc., the control module may be configured to take one or more actions. For example, the control module may be configured with the capability to switch the cable dispensing unit to the ON state, switch the cable dispensing unit to an OFF state, set or adjust a speed or rate the cable dispensing unit dispenses the electrical cable, set or adjust a speed or rate the movable biasing unit retracts the electrical cable, set or adjust an elevation and/or rotation of the crane arm, set or adjust an elevation and/or rotation of the cable management apparatus, perform an emergency stop on the movement of the crane arm and/or the cable management apparatus, and/or generate a warning. In doing so, it is possible for the cable management system to operate semi-autonomously or fully autonomously.

Such self-awareness allows the cable management system to determine the relative positions of the cable management apparatus, crane arm, and crane base, and also the relationship of these components with respect to a hazard zone and a marine vessel that is the target for receiving electrical power from the cable management system. The control module may be configured to perform continued analysis of the relative positions of the cable management system and the target vessel, and to output suitable commands (e.g. based on pre-programmed prompts) to the cable management apparatus to adjust e.g. cable length (whether to dispense or retract a portion of the cable) in order to facilitate compensation of vessel draft change and/or tidal variations. For example, a lidar may be provided to the cable management system which may detect changes in a vessel deck height, and the control module based on data received from the lidar may output commands to the cable management apparatus to dispense more cable so that the change can be compensated without the need to move the cable management apparatus or crane arm.

In another example, the cable dispensing unit and the movable biasing unit are configured to communicate with each other to coordinate cable dispensing or retracting. For example, the cable dispensing unit may be configured as the primary unit with the movable biasing unit being configured as a subordinate unit, such that the first operation mode of the cable dispensing unit signals the movable biasing unit to decrease the biasing force and the second operation mode of the cable dispensing unit signals the movable biasing unit to increase the biasing force.

Together with suitable sensors for monitoring cable tension, cable length and cable temperature, etc., such communication facilitates the maintenance of a predetermined cable tension and other features of the cable, e.g. minimum and maximum operating temperatures, maximum pull force, minimum bending radius, etc., as prescribed by the manufacturer. For example, the cable dispensing unit and movable biasing units may be controlled in a coordinated manner to prevent over-tensioning the cable, as determined by the tension ratings provided by the cable manufacturer, e.g. by adjusting the biasing force applied by the movable biasing unit based on the action of the cable dispensing unit; the cable dispensing unit may be controlled to impart a predetermined, non-destructive, clamping force on the cable so as not to exceed an upper limit on the radial and longitudinal forces acting on the cable, as determined by manufacturer data.

The control module, e.g. comprising or communicating with at least one processor, may perform the various control operations, such as the control operations described above, initially based on threshold checks. However, sensors such as e.g. temperature sensors, lidar and other positioning sensors, etc. that output sensor data for the initial threshold checks may be collected to generate data sets that can be used e.g. in point-cloud modelling. The data sets may be analysed by one or more machine learning algorithms to improve the control operations of the control module. A cable management system may comprise a cable management apparatus that manages multiple electrical cables, and only one or some of the cables are deployed and in-use during operations, in which case data analysed and machine learning performed based on the operation of the deployed cable(s) may also be communicated and applied to the cable management module (in particular the cable dispensing unit and movable biasing unit) of the unused cable(s).

Moreover, the control module may associate positioning data and data concerning the cable management apparatus to inform and generate alerts or alarms to a human operator. For example, such alerts or alarms may include: cable over-pull or over-tensioning; lack of excess cable required to compensate for tidal variation or vessel movement; proximity of the crane arm to a hazard zone, proximity of the cable management apparatus to a hazard zone, proximity of the cable management apparatus to the crane arm, overheating of the cable, verification of an acceptable or grounded connection to the port of the target vessel, proximity of the cable management apparatus to the vessel (in any of three dimensions), etc.

The examples and conditional language recited herein are intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its scope as defined by the appended claims.

Furthermore, as an aid to understanding, the above description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding and not to limit the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the technology, as well as specific examples thereof, are intended to encompass both structural and functional equivalents thereof, whether they are currently known or developed in the future.

It will be clear to one skilled in the art that many improvements and modifications can be made to the foregoing examples without departing from the scope of the present techniques.

What is claimed:

1. A cable management apparatus for storing, dispensing and/or retracting an electrical cable, the apparatus comprising:
a housing to enclose the electrical cable, the housing having a dispense opening defining a front end from which the electrical cable is dispensed and a rear end opposite the front end;
a cable dispensing unit disposed proximal to the dispense opening, the cable dispensing unit being configured to dispense the electrical cable from the dispense opening in a first operation mode; and
a movable biasing unit disposed within the housing to receive a portion of the electrical cable and to apply a biasing force on the portion of the electrical cable towards the rear end such that the electrical cable is tensioned between the cable dispensing unit and the movable biasing unit, the movable biasing unit being configured to move along at least a portion of a length of the housing to cooperatively dispense the electrical cable with the cable dispensing unit.

2. The cable management apparatus of claim 1, wherein the cable dispensing unit is configured in the first operation mode to dispense the electrical cable by drawing a length of the electrical cable out of the dispense opening, and in a second operation mode to retract the electrical cable by drawing the length of electrical cable into the housing.

3. The cable management apparatus of claim 1, wherein the movable biasing unit comprises a drive unit configured to generate and control the biasing force towards the rear end of the housing.

4. The cable management apparatus of claim 3, wherein, when the cable dispensing unit is in the first operation mode, the drive unit is configured to reduce the biasing force towards the rear end of the housing based on a dispense speed of the cable dispensing unit to allow the movable biasing unit to move towards the dispense opening, such that a predetermined tension in the electrical cable is maintained while the cable dispensing unit dispenses the electrical cable.

5. The cable management apparatus of claim 3, wherein the cable dispensing unit is configured in a second operation mode to retract the electrical cable by drawing the length of electrical cable into the housing, and the drive unit is configured to increase the biasing force towards the rear end of the housing based on a retract speed of the cable dispensing unit when the cable dispensing unit is in the second operation mode, such that a predetermined tension in the electrical cable is maintained while the cable dispensing unit retracts the electrical cable.

6. The cable management apparatus of claim 3, wherein the cable dispensing unit is configured in a third operation mode to be static, and the drive unit is configured to maintain the biasing force towards the rear end of the housing so as to maintain a predetermined tension in the electrical cable for storage.

7. The cable management apparatus of claim 3, further comprising a rail disposed within the housing extending at least the portion of the length of the housing, wherein the drive unit is slidably coupled to the rail.

8. The cable management apparatus of claim 1, wherein the movable biasing unit is a sheave comprising a circular or semi-circular wheel having a grooved rim that receives the portion of the electrical cable.

9. The cable management apparatus of claim 1, further comprising a plurality of cable dispensing units and a plurality of movable biasing units, wherein each pair of cable dispensing unit and movable sheave unit is configured to cooperatively dispense and retract a corresponding electrical cable.

10. A cable management system for facilitating electrical power transmission to a marine vessel, the system comprising:
a crane having a support base, the crane comprising a crane arm pivotally coupled to the support base, the crane arm extending from a proximal end near the support base to a distal end away from the support base, and a crane interface at the distal end of the crane arm;
the cable management apparatus of claim 1 that is pivotally coupled to the crane interface; and
at least one electrical cable.

11. The cable management system of claim 10, further comprising a monitoring system comprising at least one sensor, the at least one sensor being configured to sense: a position of the crane, a position of the cable management apparatus, a mechanical force being exerted on the at least one electrical cable, a temperature of the at least one electrical cable, one or more obstructions near the crane, the cable management apparatus, and/or the at least one electrical cable.

12. The cable management system of claim 10, wherein the monitoring system further comprises a control module configured to: switch the cable dispensing unit to the first operation mode, switch the cable dispensing unit to a second operation mode, set or adjust a speed or rate the cable dispensing unit dispenses the at least one electrical cable, set or adjust a speed or rate the movable biasing unit retracts the at least one electrical cable, set or adjust an elevation and/or rotation of the crane arm, set or adjust an elevation and/or rotation of the cable management apparatus, perform an emergency stop on a movement of the crane arm and/or the cable management apparatus, and/or generate a warning, based on sensor data output by the at least one sensor.

13. The cable management system of claim 10, wherein the at least one electrical cable comprises a plurality of electrical cables, and the cable management apparatus comprises a corresponding plurality of cable dispensing units and movable biasing unit pairs, wherein each cable dispensing unit and movable biasing unit pair is configured to cooperatively dispense or retract a corresponding electrical cable of the plurality.

14. The cable management system of claim 10, wherein the electrical cable is a low voltage flexible cable or a high voltage flexible cable.

15. The cable management system of claim 10, wherein the system is deployed in a non-hazardous area or partially in a hazard zone to facilitate electrical power transmission within the hazard zone, or when the marine vessel is a liquid bulk vessel including a chemical tanker or a crude oil tanker.
